(19) United States
(12) Patent Application Publication
(10) Pub. No.: US 2013/0149568 A1
(43) Pub. Date: Jun. 13, 2013

(54) POWER BATTERY AND ANTI-EXPLOSION DEVICE THEREOF

(71) Applicants: Dongguan Amperex Technology Litmited, Dongguan (CN); NingDe Amperex Technology Limited, Ningde City (CN)

(72) Inventors: Heng ZHANG, Dongguan (CN); Peng WANG, Dongguan (CN); Pinghua DENG, Dongguan (CN); Zhijun GUO, Dongguan (CN)

(73) Assignees: NINGDE AMPEREX TECHNOLOGY LIMITED, Ningde City (CN); DONGGUAN AMPEREX TECHNOLOGY LIMITED, Dongguan (CN)

(21) Appl. No.: 13/706,580

(22) Filed: Dec. 6, 2012

(30) Foreign Application Priority Data
Dec. 12, 2011 (CN) 201120512570.0

(51) Int. Cl. H01M 2/12

(52) U.S. Cl. CPC H01M 2/1241
USPC 429/56

(57) ABSTRACT

The invention relates to the power battery technology, especially to a power battery and anti-explosion device thereof, comprising an anti-explosion disc disposed in an anti-explosion bore. The surface of the anti-explosion disc is attached with an anti-explosion ring and an anti-explosion patch, the anti-explosion ring and the anti-explosion patch are at the same side of the anti-explosion disc and the anti-explosion ring and the anti-explosion patch form an annular groove. Compared with the prior art, the anti-explosion device has a simple structure, accurate explosion pressure, high intensity and it is not easy to be damaged. When the power battery is abnormal in use and the inner side has high pressure, the anti-explosion disc will explode under certain pressure to prevent explosion of the battery. It improves the safety of the power battery.

### FIELD OF THE INVENTION

The invention relates to the power battery technology, especially to a power battery and anti-explosion device thereof, which has a simple structure, accurate explosion pressure, high intensity and which is not easy to be damaged.

### BACKGROUND OF THE INVENTION

Power battery is preferred energy of electric vehicles and energy storage station. People have high requirements on its safety. One important index of the battery safety is the anti-explosion performance. As the power battery, under abnormal situation, i.e. short circuit or external pressure, will have high internal pressure. When the internal air pressure rises to a certain level, the metal case of the power battery will explode to cause electrolyte leakage or fire.

Power battery includes a power electric core and a battery case to hold the electric core. The battery cover includes a positive pole, a negative pole, a liquid hole and an anti-explosion hole. Generally, the anti-explosion ability of the power battery is achieved by the anti-explosion hole of the anti-explosion device.

Current, there are many power battery anti-explosion devices on the market, but they have the following defects:

1. complicated structure and high costs. Some power battery anti-explosion device uses anti-explosion cover. The structure is formed by many parts. The processing costs are high, complicated and the costs are high.

2. anti-explosion pressure is not accurate. The power battery anti-explosion devices on the market mainly scored anti-explosion devices, i.e. the metal foil is scored. The area with score is the explosion area. The weakness of this control method is that the explosion pressure is ensured by the depth and shape of the score. If they are inconsistent, the mechanical property will not be consistent. The explosion pressure will be poor. In addition, the scored area has high requirements on processing technology and the costs are high.

3. low intensity will cause break. The power battery anti-explosion devices on the market have single layer anti-explosion film. The weakness area is large (the whole anti-explosion film area). When the battery is produced or used, the air pressure difference will cause break or damage of the battery.

Therefore, it is necessary to provide a power battery anti-explosion device with simple structure, accurate explosion pressure and high intensity.

### SUMMARY OF THE INVENTION

The objective of the invention is to overcome the shortage of the prior art by providing an anti-explosion device for power battery with simple structure, accurate explosion pressure and high intensity.

The objective is realized by the following solution.

An anti-explosion device for power battery comprising an anti-explosion disc disposed in an anti-explosion bore. The surface of the anti-explosion disc is attached with an anti-explosion ring and an anti-explosion patch, the anti-explosion ring and the anti-explosion patch are at the same side of the anti-explosion disc and the anti-explosion ring and the anti-explosion patch form an annular groove. The annular groove is the explosion area.

As an improvement, the thickness of the anti-explosion disc is smaller than 0.1 mm The explosion pressure is controlled by the anti-explosion disc. The anti-explosion disc is thicker, it cannot prevent explosion. The anti-explosion disc is preferably the 0.1 mm When the battery is abnormal, the inner pressure rises to the explosion pressure, the anti-explosion device will explode to prevent the battery from explosion.

As an improvement, the thickness of the anti-explosion ring is 3 mm.

As an improvement, the thickness of the anti-explosion patch is smaller than 3 mm. As the anti-explosion disc is smaller, the anti-explosion patch is attached to the surface of the anti-explosion disc can increase intensity of the anti-explosion disc. It can prevent the anti-explosion disc from breaking when the battery is produced or used.

As an improvement, the inner diameter of the anti-explosion ring is larger than the diameter of the anti-explosion patch. The anti-explosion patch and the anti-explosion ring has an annular groove as the anti-explosion area.

As an improvement, the width of the annular groove is smaller than 3 mm.

As an improvement, the anti-explosion patch is stuck to the anti-explosion disc by adhesive bonding, welding or molecular diffusion welding which are mature and have low costs.

As an improvement, the anti-explosion ring is stuck to the anti-explosion disc by adhesive bonding, welding or molecular diffusion welding.

As an improvement, the diameter of the anti-explosion ring is larger or equal to the diameter of the anti-explosion disc.

The invention has the advantages as follows compared with the prior art.

1. high intensity and cannot break. The anti-explosion patch is stuck to the anti-explosion film to increase intensity of the anti-explosion disc. It will not break when small impact exists.

2. simple structure and low costs. Compared with the prior art, it includes many parts and the anti-explosion cover is made with complicated process. The anti-explosion device of the invention only includes three parts, i.e. the anti-explosion disc, the anti-explosion ring and the anti-explosion patch. The total thickness of the anti-explosion device is smaller than 5 mm The processing technology has low costs compared with the adhesive bonding, welding or molecular diffusion welding.

3. accurate explosion pressure. The weakness of the anti-explosion device is the annual groove formed by the anti-explosion ring and the anti-explosion patch. The explosion pressure is controlled by the thickness of the anti-explosion disc. The thickness of the anti-explosion disc is even and has consistent mechanical properties. It can explode within the designed explosion scope with small error.

When the power battery using the anti-explosion device is abnormal, the inner side of the battery will produce high air pressure. The anti-explosion disc will explode under certain pressure to prevent explosion of the battery. The safety of the battery is largely improved.

Another objective of the invention is to provide a power battery, comprising a power electric core and a battery case to hold the electric core. The battery case includes a metal case and a battery cover, the battery cover includes a positive pole, a negative pole, a liquid hole and an anti-explosion hole. The anti-explosion hole is disposed with the anti-explosion device for power battery.

### BRIEF DESCRIPTION OF THE DRAWINGS

The invention is described in detail with attached drawings.

FIG. 1 is a top view of the anti-explosion device for power battery;

FIG. 2 is a sectional view of the A-A of FIG. 1;

FIG. 3 is a sectional view of the anti-explosion device for power battery;

FIG. 4 is a top view of the cover of FIG. 3; and

FIG. 5 is an enlarged view of B of FIG. 3.

### DETAILED DESCRIPTION OF THE PREFERRED EMBODIMENTS

The invention is described in detail with attached drawings.

### Example 1

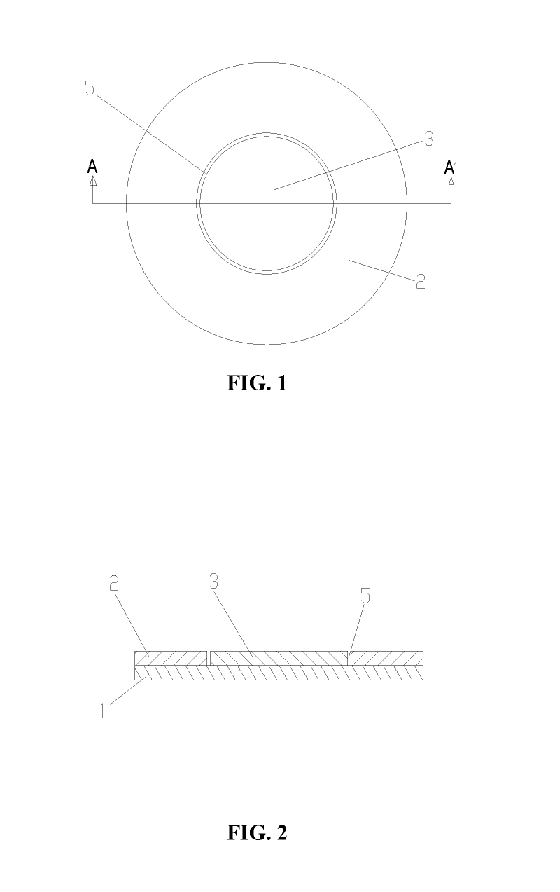

In FIG. 1 and FIG. 2, the anti-explosion device for power battery comprising an anti-explosion disc 1 disposed in an anti-explosion bore 4, the surface of the anti-explosion disc 1 is attached with an anti-explosion ring 2 and an anti-explosion patch 3, the anti-explosion ring 2 and the anti-explosion patch 3 are at the same side of the anti-explosion disc 1 and the anti-explosion ring 2, the anti-explosion patch 3 is to increase intensity of the anti-explosion disc 1. The inner diameter of the anti-explosion ring 2 is larger than the diameter of the anti-explosion patch 3; The anti-explosion ring 2 and the anti-explosion patch 3 form an annular groove 5. The width of the annular groove is smaller than 3 mm. The annular groove 5 is an anti-explosion area. The thickness of the annular groove 5 is even. It has consistent mechanical properties. It ensures the reliable and accurate explosion if the anti-explosion device.

The anti-explosion disc 1, the anti-explosion patch 3 and the anti-explosion ring 2 are made of copper, aluminum and stainless steel. The thickness of the anti-explosion disc 1 is 0.1 mm The thickness of the anti-explosion patch 3 and the anti-explosion ring 2 is smaller than 3 mm.

In operation, the anti-explosion patch 3 is attached to the anti-explosion disc 1 by adhesive bonding, welding or molecular diffusion welding. The anti-explosion ring 2 is attached to the anti-explosion disc 1 by adhesive bonding, welding or molecular diffusion welding. The anti-explosion ring 2 and the anti-explosion patch 3 are at the same side of the anti-explosion disc 1. The anti-explosion ring 2 and the anti-explosion patch 3 form annular groove 5. It is the anti-explosion device for power battery of the invention.

### Example 2

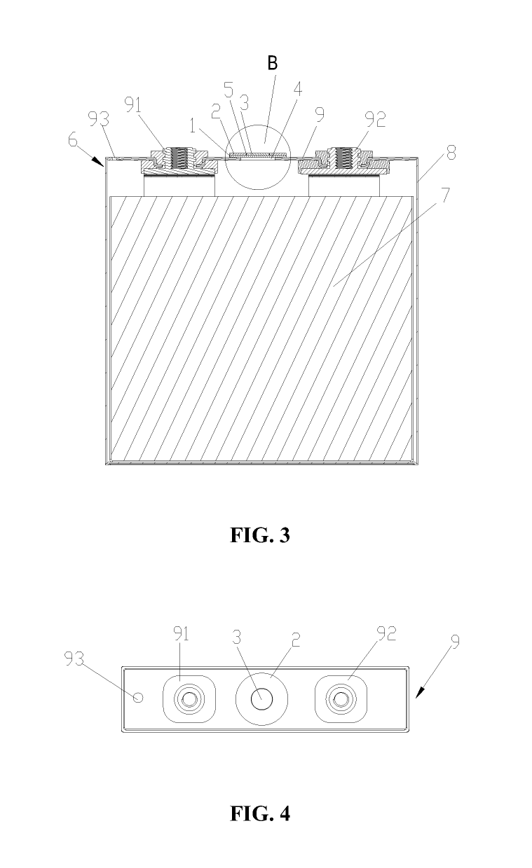

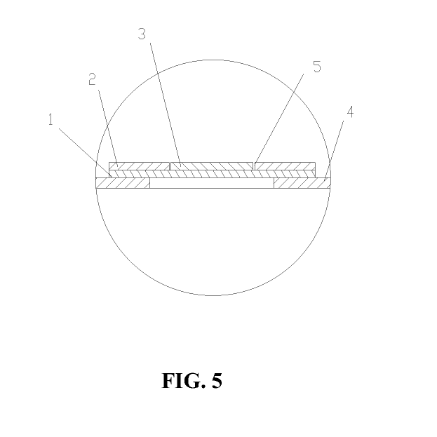

In FIG. 3, the power battery includes a power electric core 7 and battery case 6 to hold the power electric core 7, the battery case 6 includes a metal case 8 and a battery cover 9, the battery cover 9 includes a positive pole 91, a negative pole 92, a liquid hole 93 and an anti-explosion hole 4, the anti-explosion hole 4 is disposed with the anti-explosion device for power battery (as shown in FIG. 4 and FIG. 5).

In operation, the anti-explosion device for power battery with example 1 is mounted to the anti-explosion hole 4 of the battery cover 9 by adhesive bonding or welding to obtain the battery cover 9. The power electric core 7 is installed in the metal case 8. The anti-explosion hole 4 has the battery cover 9 of the anti-explosion device to be welded to the metal case 8 to obtain the power battery.

In summary, compared with the prior art, the anti-explosion device for power battery has the advantages: 1. simple structure, small volume. The power battery is made of three parts. The operation process is simple, the anti-explosion device is simple, the total thickness of the anti-explosion device is smaller than 5 mm The volume is small. 2. The explosion is accurate and reliable. The anti-explosion device has the even thickness. The mechanical properties are consistent. It can explode with designed pressure. 3. the intensity is high. It can prevent damage. The anti-explosion patch 3 is stuck to the anti-explosion disc to increase intensity of the anti-explosion disc 1. It can prevent the anti-explosion disc 1 from damaging when the battery is produced or used when the small air pressure exists.

From above description, those skilled in the art can make changes or modifications. The above embodiments are not limited to the above description. All changes and modifications are within the scope of the invention. Some terms used in the specification are used to easily describe the invention but not to limit the invention.

What is claimed is:

1. An anti-explosion device for power battery comprising an anti-explosion disc (1) disposed in an anti-explosion bore (4), wherein the surface of the anti-explosion disc (1) is attached with an anti-explosion ring (2) and an anti-explosion patch (3), the anti-explosion ring (2) and the anti-explosion patch (3) are at the same side of the anti-explosion disc (1) and the anti-explosion ring (2) and the anti-explosion patch (3) form an annular groove (5).

2. The anti-explosion device for power battery of claim 1, wherein the thickness of the anti-explosion disc (1) is smaller than 0.1 mm.

3. The anti-explosion device for power battery of claim 1, wherein the thickness of the anti-explosion ring (2) is smaller than 3 mm.

4. The anti-explosion device for power battery of claim 1, wherein the thickness of the anti-explosion patch (3) is smaller than 3 mm.

5. The anti-explosion device for power battery of claim 1, wherein the inner diameter of the anti-explosion ring (2) is larger than the diameter of the anti-explosion patch (3).

6. The anti-explosion device for power battery of claim 1, wherein the width of the annular groove (5) is smaller than 3 mm.

7. The anti-explosion device for power battery of claim 1, wherein the anti-explosion patch (3) is stuck to the anti-explosion disc (1) by adhesive bonding, welding or molecular diffusion welding.

8. The anti-explosion device for power battery of claim 1, wherein the anti-explosion ring (2) is stuck to the anti-explosion disc (1) by adhesive bonding, welding or molecular diffusion welding.

9. The anti-explosion device for power battery of claim 1, wherein the diameter of the anti-explosion ring (2) is larger than the diameter of the anti-explosion disc (1).

10. A power battery, including a power electric core (7) and battery case (6) to hold the power electric core (7), the battery case (6) includes a metal case (8) and a battery cover (9), the battery cover (9) includes a positive pole (91), a negative pole (92), a liquid hole (93) and an anti-explosion hole (4), wherein the anti-explosion hole (4) is disposed with the anti-explosion device for power battery of claim 1.

11. A power battery, including a power electric core (7) and battery case (6) to hold the power electric core (7), the battery case (6) includes a metal case (8) and a battery cover (9), the battery cover (9) includes a positive pole (91), a negative pole (92), a liquid hole (93) and an anti-explosion hole (4), wherein the anti-explosion hole (4) is disposed with the anti-explosion device for power battery of claim 2.

12. A power battery, including a power electric core (7) and battery case (6) to hold the power electric core (7), the battery case (6) includes a metal case (8) and a battery cover (9), the battery cover (9) includes a positive pole (91), a negative pole (92), a liquid hole (93) and an anti-explosion hole (4), wherein the anti-explosion hole (4) is disposed with the anti-explosion device for power battery of claim 3.

13. A power battery, including a power electric core (7) and battery case (6) to hold the power electric core (7), the battery case (6) includes a metal case (8) and a battery cover (9), the battery cover (9) includes a positive pole (91), a negative pole (92), a liquid hole (93) and an anti-explosion hole (4), wherein the anti-explosion hole (4) is disposed with the anti-explosion device for power battery of claim 4.

14. A power battery, including a power electric core (7) and battery case (6) to hold the power electric core (7), the battery case (6) includes a metal case (8) and a battery cover (9), the battery cover (9) includes a positive pole (91), a negative pole (92), a liquid hole (93) and an anti-explosion hole (4), wherein the anti-explosion hole (4) is disposed with the anti-explosion device for power battery of claim 5.

15. A power battery, including a power electric core (7) and battery case (6) to hold the power electric core (7), the battery case (6) includes a metal case (8) and a battery cover (9), the battery cover (9) includes a positive pole (91), a negative pole (92), a liquid hole (93) and an anti-explosion hole (4), wherein the anti-explosion hole (4) is disposed with the anti-explosion device for power battery of claim 6.

16. A power battery, including a power electric core (7) and battery case (6) to hold the power electric core (7), the battery case (6) includes a metal case (8) and a battery cover (9), the battery cover (9) includes a positive pole (91), a negative pole (92), a liquid hole (93) and an anti-explosion hole (4), wherein the anti-explosion hole (4) is disposed with the anti-explosion device for power battery of claim 7.

17. A power battery, including a power electric core (7) and battery case (6) to hold the power electric core (7), the battery case (6) includes a metal case (8) and a battery cover (9), the battery cover (9) includes a positive pole (91), a negative pole (92), a liquid hole (93) and an anti-explosion hole (4), wherein the anti-explosion hole (4) is disposed with the anti-explosion device for power battery of claim 8.

18. A power battery, including a power electric core (7) and battery case (6) to hold the power electric core (7), the battery case (6) includes a metal case (8) and a battery cover (9), the battery cover (9) includes a positive pole (91), a negative pole (92), a liquid hole (93) and an anti-explosion hole (4), wherein the anti-explosion hole (4) is disposed with the anti-explosion device for power battery of claim 9.
